(19) United States
(12) Patent Application Publication
(10) Pub. No.: US 2012/0175409 A1
(43) Pub. Date: Jul. 12, 2012

(54) Recycling Container

(75) Inventors: Mark McNay, Springfield, MO (US); Rick Correll, Springfield, MO (US); Gary Robinson, Springfield, MO (US); Alan Miller, Springfield, MO (US)

(73) Assignee: Southern Missouri Containers, Inc.

(21) Appl. No.: 12/985,956

(22) Filed: Jan. 6, 2011

(51) Int. Cl. B65D 5/56; B31B 7/00; B31B 1/26; B65D 5/66; B31B 1/90

(52) U.S. Cl. 229/131.1; 229/5.81; 493/110; 493/162

(57) ABSTRACT

A recycling container with a weather-resistant coating is described. The container may be provided in a variety of configurations to accept recyclable waste or other items of trash or refuse. The recycling container may itself be recycled when its useful life has ended. The various configurations of container may be combined to form a modular recycling center as desired by the user.

### BACKGROUND

### Field of the Invention

The recycling container described herein is in the field of reusable and recyclable containers for receiving and storing trash, refuse, and recyclable waste. The containers are capable of reuse, and are also constructed of materials that are themselves recyclable. In preferred embodiments of the container they are formed from corrugated fiberboard material that has been coated to provide enhanced characteristics. The material utilized in the construction of the containers is capable of outdoor use and is weather-resistant while still capable of being recycled in a similar manner to other types of fiberboard materials. In some embodiments the material provides a printing substrate that is durable and receptive to printing. The containers include interchangeable lids designed for aiding the user in sorting the waste into separate containers based upon the type of waste material.

Other types of disposable containers with weather-resistance and desirable printing qualities are known using corrugated fiberboard as a base material, but these containers are not recyclable. Such containers are typically converted, printed and then coated with a layer of petroleum wax to impart water resistance to the container. The base material described in this application, and the container created from the base material, offer a variety of improved characteristics over the materials and products currently known in this field.

### SUMMARY OF THE INVENTION

A recycling container comprising a base component and a lid component is described, wherein the base and lid components are formed from a weather-resistant recyclable material. In some embodiments of the recycling container, the weather-resistant recyclable material is corrugated fiberboard coated with a weather-resistant recyclable coating. The fiberboard utilized in the container may be manufactured from recycled material.

The container is manufactured by a process comprising the steps of providing a base material; applying a weather-resistant recyclable coating to the base material; and constructing a recyclable container from the coated base material. The process of manufacturing the container may further comprise the steps of constructing a base component from the coated base material; and constructing a lid component from the coated base material.

### BRIEF DESCRIPTION OF THE DRAWINGS

FIG. 1A is a front plan view of an embodiment of the recyclable container.

FIG. 1B is a top plan view of an embodiment of the recyclable container.

FIG. 1C is a back plan view of an embodiment of the recyclable container.

FIG. 1D is a bottom plan view of an embodiment of the recyclable container.

FIG. 1E is a side plan view of an embodiment of the recyclable container.

FIG. 1F is a perspective view of an embodiment of the recyclable container.

FIG. 2A is a front plan view of an embodiment of the recyclable container.

FIG. 2B is a top plan view of an embodiment of the recyclable container.

FIG. 2C is a back plan view of an embodiment of the recyclable container.

FIG. 2D is a bottom plan view of an embodiment of the recyclable container.

FIG. 2E is a side plan view of an embodiment of the recyclable container.

FIG. 2F is a perspective view of an embodiment of the recyclable container.

FIG. 3A is a front plan view of an embodiment of the recyclable container.

FIG. 3B is a top plan view of an embodiment of the recyclable container.

FIG. 3C is a back plan view of an embodiment of the recyclable container.

FIG. 3D is a bottom plan view of an embodiment of the recyclable container.

FIG. 3E is a side plan view of an embodiment of the recyclable container.

FIG. 3F is a perspective view of an embodiment of the recyclable container.

FIG. 4A is a front plan view of an embodiment of the recyclable container.

FIG. 4B is a top plan view of an embodiment of the recyclable container.

FIG. 4C is a back plan view of an embodiment of the recyclable container.

FIG. 4D is a bottom plan view of an embodiment of the recyclable container.

FIG. 4E is a side plan view of an embodiment of the recyclable container.

FIG. 4F is a perspective view of an embodiment of the recyclable container.

FIG. 5A is a front plan view of an embodiment of the recyclable container.

FIG. 5B is a top plan view of an embodiment of the recyclable container.

FIG. 5C is a back plan view of an embodiment of the recyclable container.

FIG. 5D is a bottom plan view of an embodiment of the recyclable container.

FIG. 5E is a side plan view of an embodiment of the recyclable container.

FIG. 5F is a perspective view of an embodiment of the recyclable container.

FIG. 6A is a front plan view of an embodiment of the recyclable container.

FIG. 6B is a top plan view of an embodiment of the recyclable container.

FIG. 6C is a back plan view of an embodiment of the recyclable container.

FIG. 6D is a bottom plan view of an embodiment of the recyclable container.

FIG. 6E is a side plan view of an embodiment of the recyclable container.

FIG. 6F is a perspective view of an embodiment of the recyclable container.

### DETAILED DESCRIPTION

The recycling container comprises a container for receiving waste, refuse and recyclable materials. In the embodiments shown in the figures, the containers are formed from a base component and a lid component. Both the lid and base component are typically formed by folding and fastening, by means of glue, brads, staples or other fastening means, various shapes of sheet materials into the desired forms. In some embodiments the lid and base components may be formed from a single sheet of base material.

In the embodiments shown in the figures, the base component comprises a bottom sheet that is substantially rectangular, but that may be other shapes in other embodiments of the container. Extending upwardly from the bottom surface are back, front and side walls sufficient to form an enclosed space comprising the interior of the container. The back wall is typically taller than the front wall, and the side walls are non-rectangular such that the top edges of the side walls of the base component slope down from the back wall to the front wall. The exact configuration and slope of the top edges of the walls may vary from those depicted in the figures.

In the embodiments shown in the figures, the lid component comprises a top sheet with side walls extending downwardly from the top surface. The side walls on the lid component are disposed to overlap and receive the top edges of the side walls of the base component, and the lid component may be removed by lifting it off of the base component. The side walls of the lid component may be formed so as to shield the open flutes of the corrugated fiberboard from the environment, such as by folding the side walls so that the exposed edge is disposed adjacent to the bottom side of the top sheet of the lid component. In other embodiments of the container, the lid component may be formed as part of the base component, and may be fixed to the base component along one or more edges thereof.

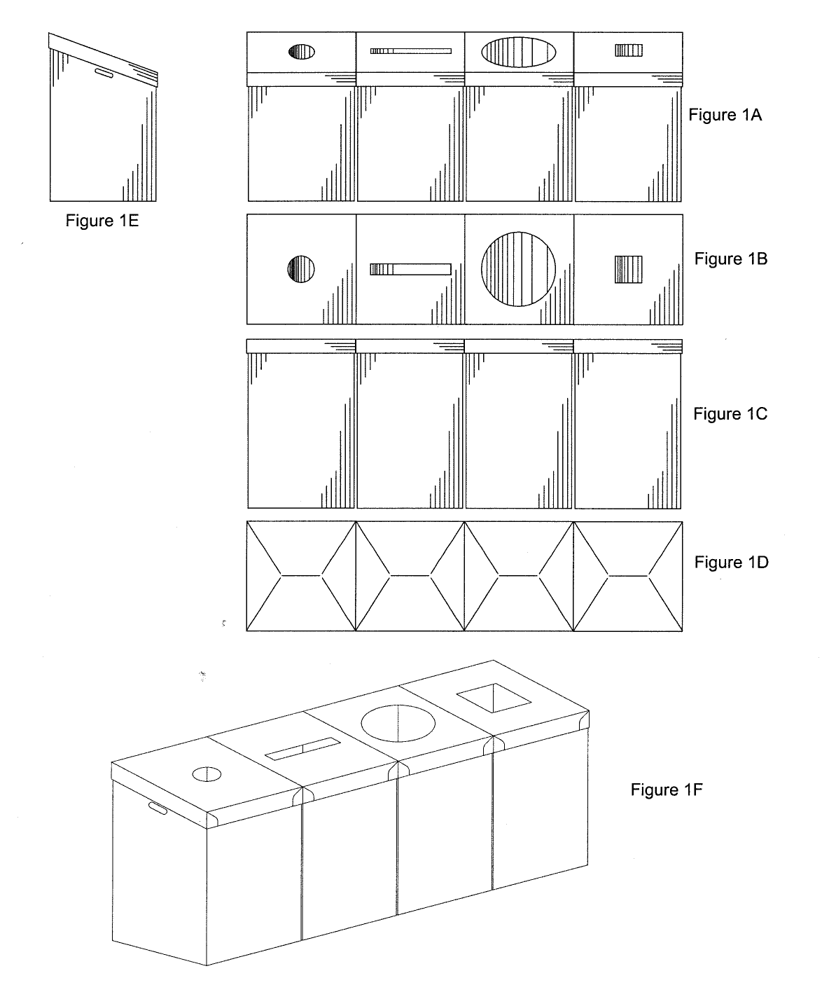

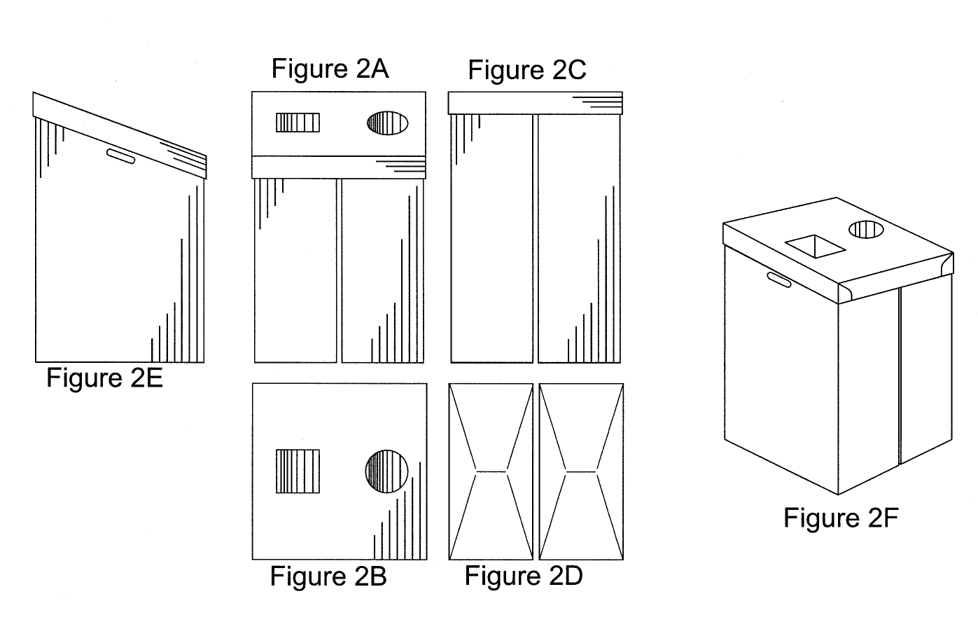

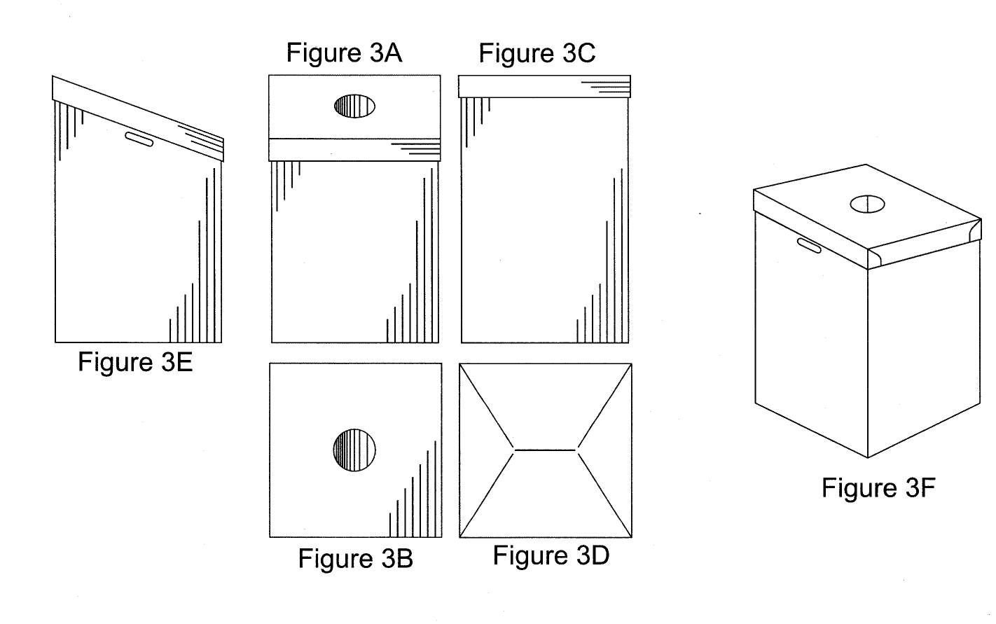

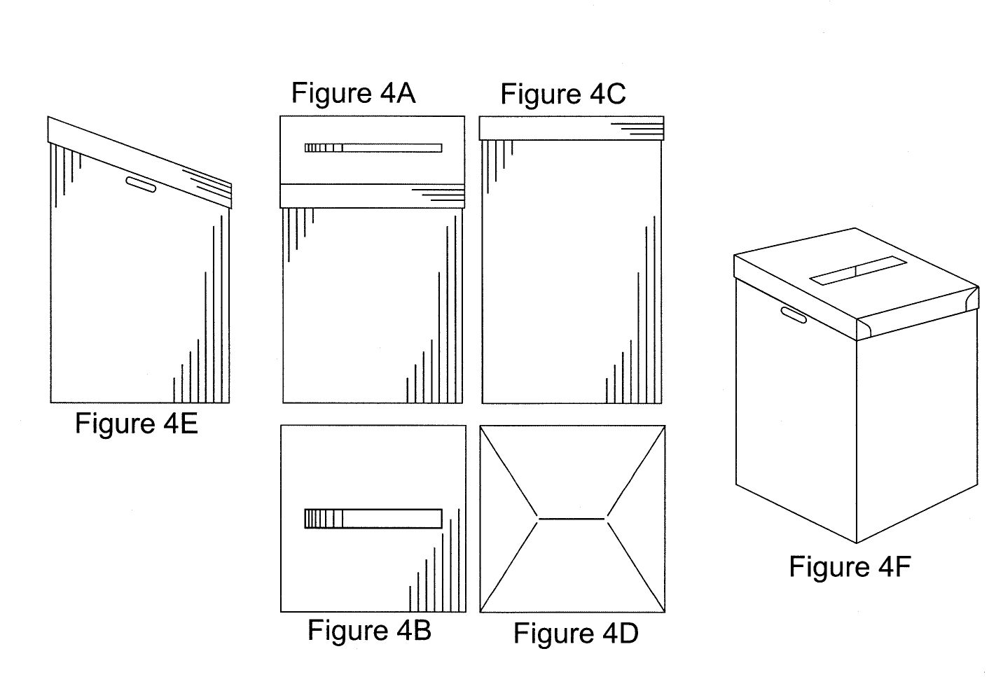

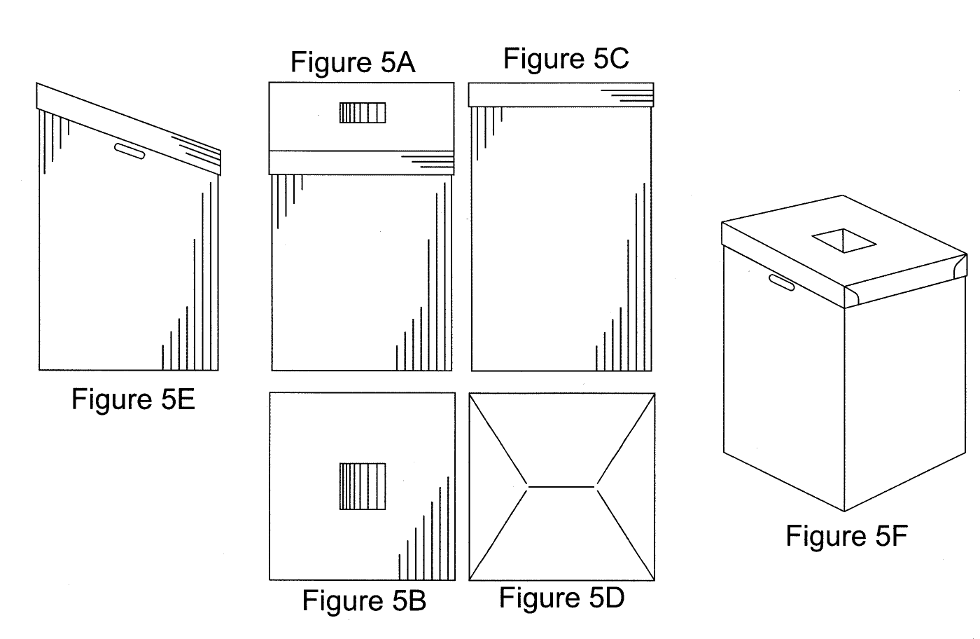

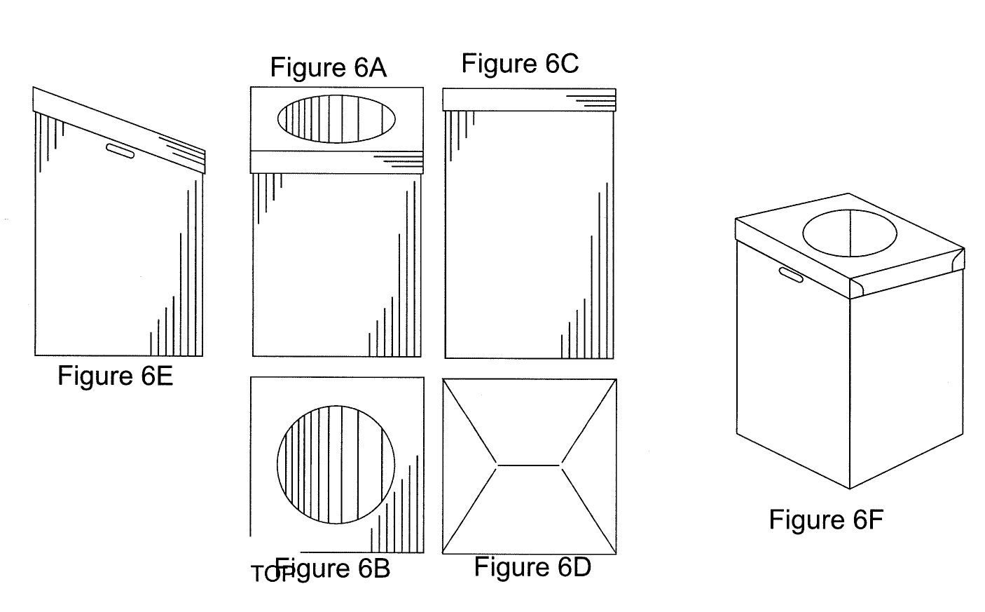

As are shown in the various figures, the lid component may be modified to accept various types of waste material. For example, FIGS. 3A-3F depict an embodiment of the container with a lid component designed to accept recyclable cans, FIGS. 4A-4F depict an embodiment designed to accept paper refuse, FIGS. 5A-5F depict an embodiment designed to accept plastic waste material, and FIGS. 6A-6F depict an embodiment designed to accept general trash. As can be seen in FIGS. 1A-1F, various containers may be combined to form a modular recycling center capable of receiving a variety of waste and recyclable materials. Such a recycling center is comprised of a plurality of the containers depicted in FIGS. 2A-6F, arranged in any order and in any combination for providing for the recycling needs of the user.

In some embodiments, such as that shown in FIG. 2, a multi-compartment container is provided. The base component in such a unit has two or more subcompartments, and the lid is provided with an opening for each subcompartment. Typically different types of refuse will be deposited in each container. It will be clear to one of skill in the art that additional types of containers, of varying shapes and sizes may be provided and still be within the scope of the described container.

The material from which the container is formed comprises a base material with a coating that provides unique properties to the container. In preferred embodiments of the container, the base material is corrugated fiberboard. In a preferred embodiment of the container, the container is formed of fiberboard manufactured entirely from post-consumer recycled paper or OCC (Old Corrugated Containers) for the liner and the medium of the fiberboard. A coating is applied to the fiberboard that imparts water-resistant properties to the fiberboard without impacting future recycling of the fiberboard. The container is entirely recyclable at the end of its useful life.

Although described as a coating, it is understood that the coating may penetrate the base material partially or fully and be impregnated therein. In that case the coating may be considered a treatment applied to the volume of the base material, and not just a surface coating on the base material. The use of the word coating through the application and claims shall apply equally to a surface coating of the base material and a treatment wherein the coating material penetrates or impregnates the base material.

The coating is described herein as a recyclable coating. It should be understood that as described herein the coating is considered recyclable if the base material that has been coated or treated with the coating may still be recycled for use as an input to making more of the base material. It is not necessary that the coating itself can be removed from the base material and recycled to make more coatings.

The coating, applied as described herein, imparts a variety of desirable components to the base material, including weather-resistance, desirable print qualities and is gluable with cold-set PVA, without preventing the material from being recycled with other fiberboard materials. One example coating that may be used in embodiments of the container is the Texguard 44F coating by Texcoat. The coating is applied to the base material by a specialized off-line coating process that may vary depending on the coating utilized in the embodiment of the invention. The coating allows for color-fast printing on the coated base material that is weather-resistant and durable in extended outdoor use.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

What is claimed is:

1. A recycling container comprising a base component and a lid component wherein the base and lid components are formed from a weather-resistant recyclable material.

2. The recycling container of claim 1 wherein the weather-resistant recyclable material is corrugated fiberboard coated with a weather-resistant recyclable coating.

3. The recycling container of claim 2 wherein the fiberboard is manufactured from recycled material.

4. A process for making a recyclable container comprising the steps of:
providing a base material;
applying a weather-resistant recyclable coating to the base material;
constructing a recyclable container from the coated base material.

5. The process of claim 4 wherein the base material is corrugated fiberboard manufactured from recycled material.

6. The process of claim 5 wherein the step of constructing a recyclable container from the coated base material further comprises the steps of:
constructing a base component from the coated base material; and
constructing a lid component from the coated base material.

7. The process of claim 6 further comprising the step of recycling the coated base material.
